(19) United States
(12) Patent Application Publication
(10) Pub. No.: US 2008/0168078 A1
(43) Pub. Date: Jul. 10, 2008

(54) System and Method For Extracting User Selected Data From a Database

(75) Inventor: Michael Francis, Buckinghamshire (GB)

Correspondence Address: FLYNN THIEL BOUTELL & TANIS, P.C., 2026 RAMBLING ROAD, KALAMAZOO, MI, 49008-1631, US

(73) Assignee: LIGHT FOOT SOLUTIONS LIMITED, Marlow, Bucks (GB)

(21) Appl. No.: 10/586,004

(22) PCT Filed: Jan. 12, 2005
(86) PCT No.: PCT/GB2005/000074

§ 371 Date: Mar. 3, 2008

(30) Foreign Application Priority Data
Jan. 12, 2004 (GB) 0400569.0

(51) Int. Cl. G06F 17/30

(52) U.S. Cl. 707/102; 707/E17.005

(57) ABSTRACT

A system and method are provided for extracting user selected data from a database. Configuration data is stored defining how a user selected data is to be extracted in response to a user request. A database query is generated from the user request using the configuration data and data extracted in response to the query. This extracted data is supplied to the user. The database query includes data defining to be measured and displayed and data defining any dimensions for that measure selected by the user. The data defining the measure and dimensions are a portion of the configuration data. Another aspect of the invention provides a method and apparatus for supplying a set of chart data from a database to a user in response to the user input. A number of sets of chart data are stored in a cache memory and a determination is made as to whether or not a user input corresponds to a request for a set of chart data stored in the cache memory. A set of chart data is supplied from the cache memory to the user in dependence on the result of the determination.

This invention relates to a system and method for extracting user selected data from a database. Another aspect relates to a method and apparatus for supplying a set of chart data from a database to a user.

### BACKGROUND TO THE INVENTION

Ever since the concept of a process, or indeed any measurable activity, has existed there has been the desire to measure it and improve upon it. In the modern world we encounter processes everywhere from ordering a sandwich to the building of a car. Any of these processes can be graphically monitored by looking at some measure plotted against the relevant processes dimension, which is typically time, but could be any other dimension such as length.

In the 1950's a statistician called Deming took this idea to the manufacturing industry and showed that by applying a statistical rule to the data being displayed it was possible to show on the chart those points which were part of the normal variability of a process and those that were outside. These charts utilise three extra lines superimposed on top of the data, an average line and top and bottom process guidelines, the position of these lines on the chart being derived from the data rather than some arbitrary position. Significant events, by which we mean something out of the ordinary, are those points outside the process guidelines and by investigating and acting upon these; improvements in the performance of the process can be achieved. The charts are well known in the manufacturing industry as Statistical Process Control (SPC) charts and have been widely used in manufacturing since the early 1950's to great effect.

The problem faced by those seeking to implement SPC charts for a process within a business is that there is simply no enterprise wide, simple to configure, general purpose SPC tool that is relevant to every one in an organisation. To date, SPC charts and the software that displays them have remained in the domain of the statisticians and engineers looking after complex manufacturing processes.

In particular, the charts are limited by the lack of a mechanism to filter the charts by one or more dimensions, the representation of measure data that allows the charts to be aggregated and/or drilled down on, and a mechanism to efficiently supply a relevant chart when there is a large amount of data to analyse to any number of users in an organisation, and to insert new measures into the system once the system is in place.

### SUMMARY OF THE INVENTION

Embodiments of the present invention include a system method and computer program for obtaining measure data from one or more external systems, processing & analysing the data, storing the data, and then displaying the data in the form of a dashboard of dials which link to various charts, including SPC charts. Each person in the organisation has the option to view charts that are uniquely relevant to them. Preferably the system uses standard web browser technology to view the charts and scales from a single user installation to the entire organisation.

One embodiment of the invention provides a system which enables selection of data from multiple points in a set of dimensions, to allow disjunction in the case of multiple points selected within the same dimension, and multidimensional analysis in the case of points selected in different dimensions.

A preferred embodiment of the invention provides a method of storing specific dimension information separate from the more generalised measure data in such a way that a dimension hierarchy can be modified, including the addition of hierarchy levels, without change to the Database Schema or measure data, thereby producing a more maintainable database.

An embodiment of a second aspect of the present invention comprises the storing of the data processed for recently accessed charts in a cache memory thereby reducing the time taken to produce these charts for subsequent queries.

Preferably the charts are regenerated if the underlying data has changed.

A further embodiment of the second aspect comprises automatically generating a set of frequently used charts and caching the data points for these charts.

Preferably the frequently used charts have their data points recalculated and cached in response to changes in the underlying data.

Embodiments of the invention will now be described in detail by way of example with reference to the accompanying drawings in which:

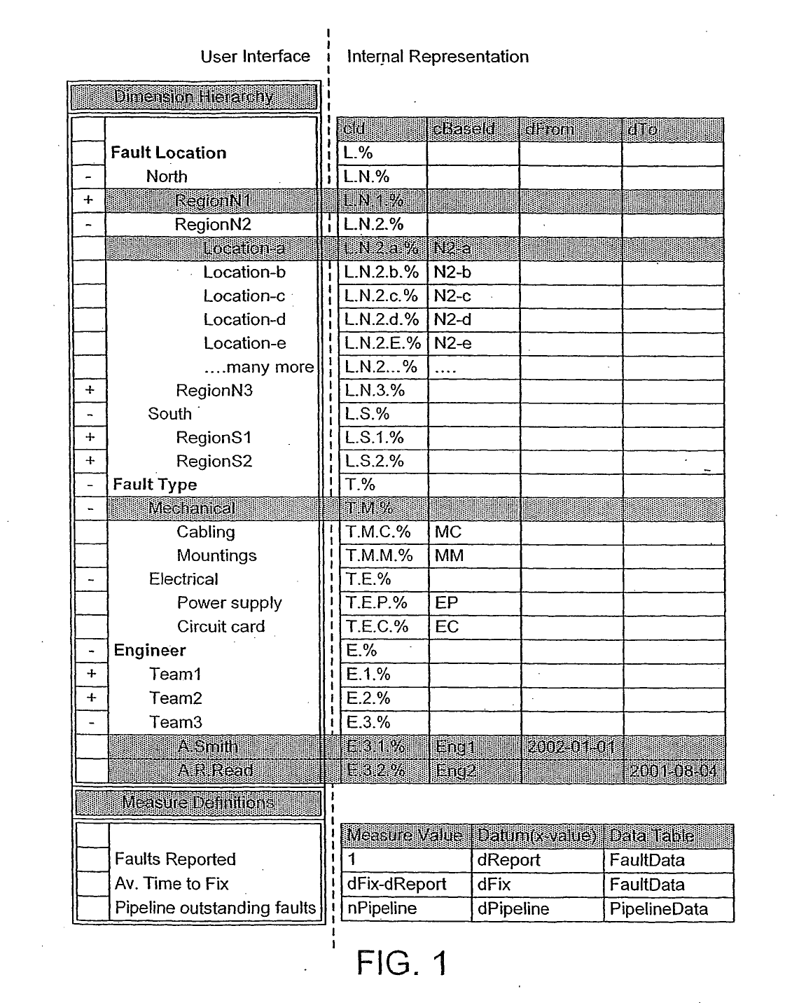

FIG. 1 shows a schematic diagram of a set of Dimension Hierarchies and a Measure Hierarchy,

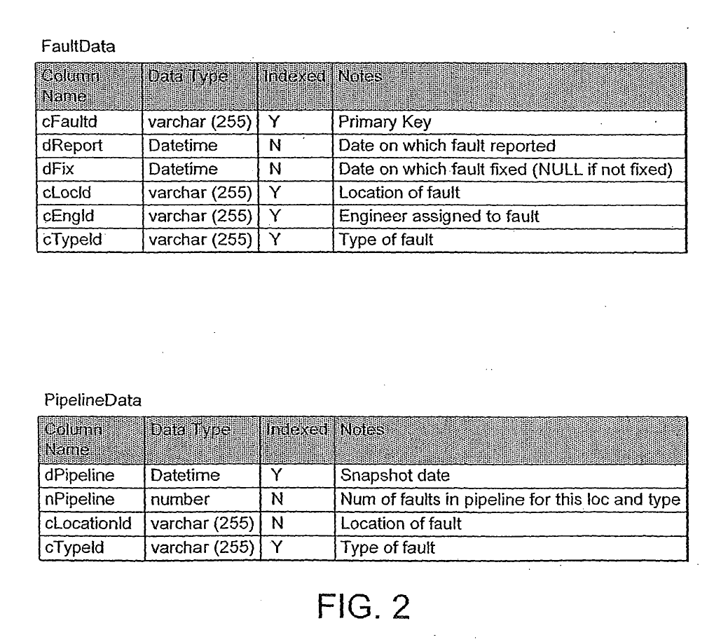

FIG. 2 shows the structure of the Measure Data used in the examples;

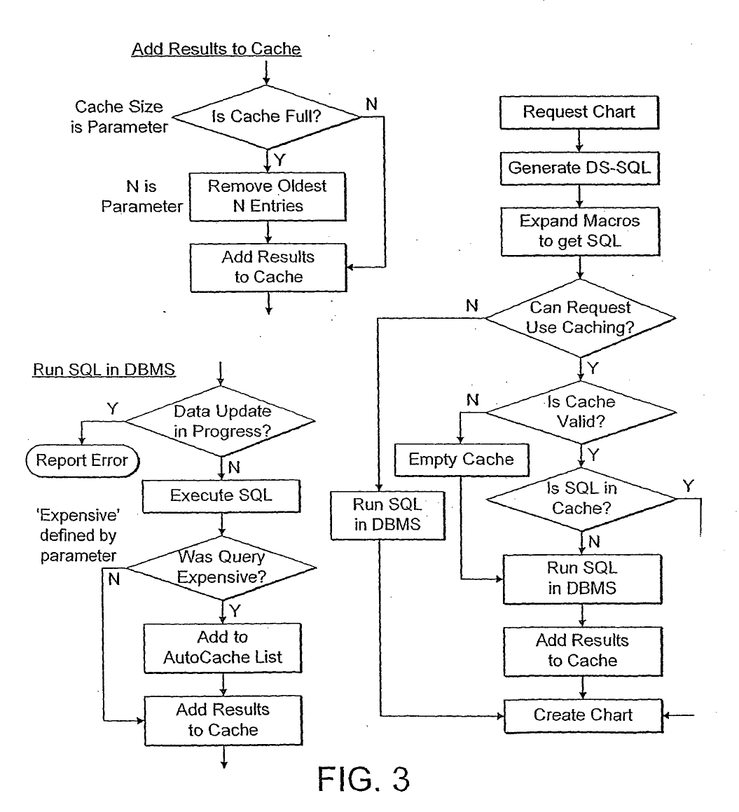

FIG. 3 shows a diagram of the caching/autocaching system embodying a second aspect of the invention; and

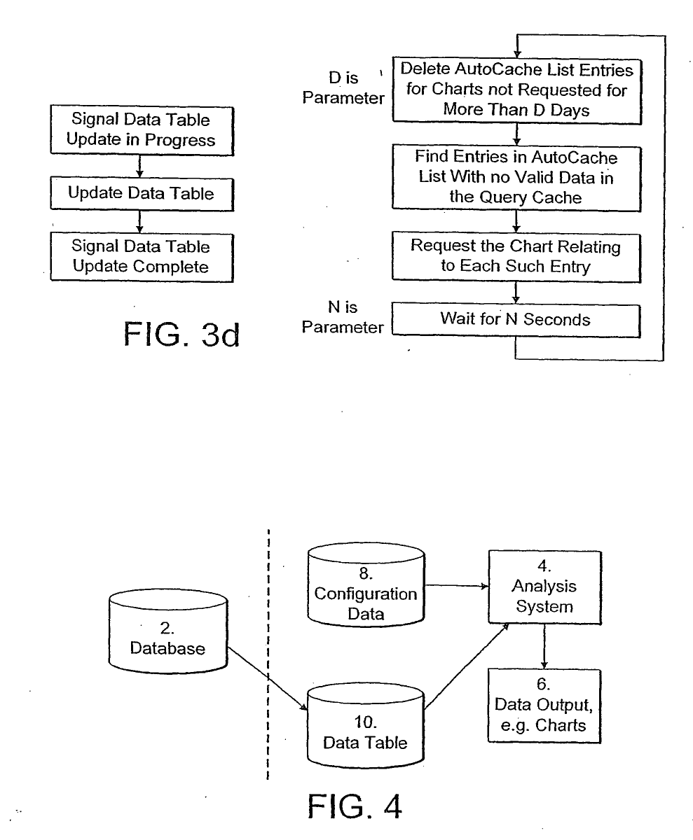

FIG. 4 is a block diagram of a system embodying the invention.

Wherever data is to be analysed and subsequently represented in SPC charts, the form which the raw data takes must be understood. Frequently there will be a body of historical data, usually stored in some form of database.

FIG. 4 shows a block diagram of the system embodying the invention. This comprises a database 2 of customer data to be analysed. An analysis system 4 is provided which sends data after analysis to a data output system which, for example, can produce graphical output such as SPC charts.

A store of configuration data 8 is provided. This includes measures to be used in analysing the data and various dimensions relating to those measures which can be arranged in some form of dimension hierarchy.

A data table store 10 is used to extract data to be analysed from the database. The data which is extracted is dependent on the configuration data 8.

When a particular user request is received by the analysis system 4 to produce some form of data output from the underlying database 2, the request will be dependent on the measure and dimension data stored in configuration data. A query will be generated for the data table 10 which will return the data to the analysis system 4 for subsequent output to the data output system 6. Thus, the configuration data is used to filter the data from the data table for user selected output.

In order to produce usable SPC charts, there must first be definition of what is to be represented by the charts. For example, a chart could be defined which shows fault occurrences in a particular piece of equipment across an organisation against time. Fault occurrence would therefore be the measure being considered. In association with this there are various dimensions. These could be e.g. fault location, fault type, or any other that might be required.

In some cases this data will be easily accessible within an existing database. In this case, a system for extracting data from the database can be devised which either links directly to the data in the database, or extracts it to a data table and then links it to construct an SPC chart.

Where the data is present in the database but is not in a suitable format, it is necessary to extract it to a data table.

The specification of a Data Table is dependent on the Measures to be used to analyse it, and on the Dimensions to be used to filter it. The relevant data can be extracted to a data table. If it is available in appropriate form in the database it can remain in that location.

One embodiment of the invention provides a method of storing Dimension information separate from the measure data in such a way that the Dimension Hierarchy (DH) can be modified, including the addition of hierarchy levels, with no change to the Database Schema or measure data, thereby producing a more maintainable database.

The DH is, in general, a set of Dimensions, joined into one hierarchy by grouping nodes, analogous to folders and directories in an Operating System. In the following example, Dimension nodes are shown in bold, and the top-level grouping node in bold italic:

```

[symbol]

  Geographical
    North
      Eng01
      Eng02
      ...
    South
      Eng03
      Eng04
      ...
    Functional
      Sales
      Support
```

Typically, Data is related only to the nodes the bottom of the hierarchies (though due to preaggregation or coarse granularity of data, this may not always be the case). Data is considered ‘Appropriate’ to a node in the hierarchy if it relates to that node or any node below. Data Appropriate to a node is displayed in charts for that node. This method of aggregation allows the hierarchy to be restructured without any Data implications. For example, another level, Country, might be added in the above hierarchy below Geographical, with North and South now coming under each Country. Only the contents of the Database Table representing the Hierarchy itself would need to be modified.

A row of Data relates to a node in the DH, for a given Measure, if the node's cBaseId value matches the value extracted from the data row for the Dimension to which the node belongs. This is the only link between the DH and the Data.

The system provides a mechanism for representing the measure on an SPC chart. Once represented, individual measure points on the chart can be selected and drilled down into by selecting a particular dimension and filtering this. Thus highly relevant data can be extracted. Alternatively a whole chart may be filtered using a user selected dimension.

The configuration data includes the specification of the source Data Table for each Measure; this may be an extracted Data Table, or a table in the existing customer database.

An example of the dimensions which are available to a user to examine for a fault measure are shown on the left hand side of FIG. 1. The internal data extracted to a data table to show this is shown on the right hand side of FIG. 1.

Generation of the Main Database Query_{[PTI]}

In order to meet the requirement that charts should be generated in a timely manner, an SPC Chart request must be converted into an efficient query e.g. an SQL query (where the data is in an SQL compliant database).

There is an optimised main query format comprising a measure to be extracted, and any user selected dimensions associated with that measure. Measure and dimension data to be used in generating the query are stored in the configuration data.

To minimise the amount of data passed between the database and a query server, the query should also produce the minimum amount of data for each SPC Chart point (typically a single row from a single query e.g. a single co-ordinate pair for a single data point).

The form of the query should be such that the Database System is able to produce an efficient execution plan; this will generally include the use of indexes. In order for this to happen, indexes on all dimension columns in Data Tables are required. Indexes are also placed on some columns in the table describing the Dimension Hierarchies.

An SPC Chart request includes the following information:
The Measure to be displayed
   This allows the following to be determined:
   a) The Data Table from which to read the Measure Data, FIG. 2 gives examples of Data Tables.
   b) The expression to use to extract the Measure value from a row in this Data Table
   c) The expression to use to extract the Date (or other datum) value from a row in this Data Table (<datumSQL>)
   d) The Partitioner to use: How to partition the data rows (by day, month, year, etc.)
   e) The Time Reducer to use: How to combine values in a Partition over time (sum, mean, etc.)
   f) The Hierarchy Reducer to use: How to combine values after Time Reduction, to aggregate over a Dimension Hierarchy
The Selections in the Dimension Hierarchies

There is a matrix of SQL expressions, which describes how to get the value for each of the Dimensions from each of the Data Tables being used; this is defined as part of the configuration data. For example, if we have Dimensions Location, Engineer, and Fault Type, and we have Data Tables FaultData and PipelineData (See FIG. 2), we might have the following:

| Dimension | | |
|---|---|---|
| SQL | FaultData | PipelineData |
| Location | cLocId | cLocationId |
| Engineer | cEngId | |
| Type | cTypeId | cTypeId |

To get the value for Location from FaultData, the SQL expression cLocId is used. To get the value for this dimension from PipelineData, the expression cLocationId is used. Which table, FaultData or PipelineData, is used depends on the particular measure to be displayed., note that PipelineData does not have a value for the Engineer Dimension and so a measure derived from this table cannot be filtered by the Engineer dimension.

Multiple selections within a Dimension are interpreted as a disjunction (i.e. ‘OR’). The resulting ‘OR’ expressions from all Dimensions are then ‘AND’ed.

The Dimension Hierarchies are represented by the following Database Table, with one row for each node. There is a single root node grouping the Dimension nodes, which may be in further subgroups for convenience.

SfnDimensionHierDesc

| Column | | | |
|---|---|---|---|
| Name | Data Type | Indexed | Notes |
| cDesc | varchar(255) | N | Description of a node in the |
| | | | Organisation Hierarchy |
| cId | varchar(255) | Y | Unique Hierarchy-Encoded ID |
| | | | for this node. |
| CBaseId | varchar(255) | Y | Attribute value - may be NULL if |
| | | | no data ever matched by this node |
| dForm | Datetime | N | Time when cBaseId starts to relate to |
| | | | cId |
| To | Datetime | N | Time when cBaseId ceases to relate |
| | | | to cId |
| blsGroup | number | N | 1 if this is a Grouping Node, |
| | | | 0 otherwise |

Hierarchy-Encoded IDs describe the path to a node. For example, A.B.C. % is a child of A.B. %, which is a child of A. %, which is a child of the root %. This is further shown in FIG. 1, the left hand side of the diagram shows the user view of the hierarchy, the right hand side of the diagram shows the hierarchy-encoded ids in the column cId.

The Attribute value, held in cBaseId, is the value used to match this node against a row of data, by calculating the Dimension value for the Dimension of which this node is a descendent. For example, suppose that just the Location-a node is selected in the Dimension Hierarchy, and a chart is requested for a Measure that gets its data from the table FaultData. The cBaseId value for Location-a is N2-a, and this node is a descendent of the Dimension Node Fault Location. Values for this dimension are defined as coming from the column cLocId for Data Table FaultData, so a filter condition on the data from the FaultData table is created to implement the selection as follows:

cLocId=‘N2-a’

(see below for more complete examples).

A node can be marked as only being active over a certain date range [dFrom, dTo). NULL values in either column indicate no start or no end date respectively. This allows ‘relocation’ of nodes at a particular date (e.g. employee moving from one office to another).

Supposing the Dimensions are as shown in FIG. 1, and a Measure is selected which has the same Reducer specified for Time and Hierarchy (this applies to the Faults Reported and Av. Time to Fix Measures in FIG. 1).

The query generated will be in the same general format irrespective of the user request and in this example will have the following form:

```
  SELECT <pointIdSQL(<datumSQL>)> AS nPointId_,
      <red(<measSQL>)> AS nRedValue_{—}
  FROM FaultData D_,
    SfnDimensionHierDesc H_1,
    SfnDimensionHierDesc H_2
  WHERE
  ---- Conditions relating to selections in Location Dimension
      (H_1.cId LIKE ‘L.N.1.%’ OR H_1.cId LIKE ‘L.N.2.a.%’)
  AND H_1.cBaseId = cLocId
  AND (H_1.dFrom IS NULL OR H_1.dFrom <= <datumSQL>)
  AND (H_1.dTo IS NULL OR H_1.dTo  >‘<datumSQL>)
  ---- Condition relating to selections in Engineer Dimension
  AND (  cEngId = ‘Eng1’ AND <datumSQL> >= ‘2002-01-01’
      OR cEngId = ‘Eng2’ AND <datumSQL> <  2001-08-04’)
  ---- Conditions relating to selections in Fault Type Dimension
  AND H_2.cId LIKE ‘T.M.%’
  AND H_2.cBaseId = cTypeId
  AND (H_2.dFrom IS NULL OR H_2.dFrom <= <datumSQL>)
  AND (H_2.dTo IS NULL OR H_2.dTo > < datumSQL>)
  AND <datumSQL> IS NOT NULL
GROUP BY <pointIdSQL(<datumSQL>)>
ORDER BY 1
(Bold text denotes identifiers and values specific to the example Dimension Hierarchy and Measures)
```

<pointidSQL(<datumSQL>)> is a SQL expression to get an integer value from the <datumSQL> such that consecutive partitions (e.g. days) give increasing consecutive values.

The form of this SQL depends on the Partitioner specified for the Measure. <red(<measSQL>)> is a SQL aggregate expression, which ‘reduces’ the set of values, obtained by evaluating <measSQL> for all of the selected rows, to a single value. This is typically a SUM or MEAN.

The form of this SQL depends on the Reducer specified for the Measure.

Depending on the Measure selected, the following values would be used:

| | Fault | |
|---|---|---|
| | Count | Av. Time to Fix |
| <measSQL> | 1 | dFix − dReport |
| <datumSQL> | dReport | dFix |
| <red(<measSQL>)> | SUM(1) | AVG(dFix − dReport) |
| <locDimSQL> | cLocId | cLocId |
| <engDimSQL> | cEngId | cEngId |
| <typDimSQL> | cTypeId | cTypeId |

Because non-leaf nodes are selected in the Fault Location and Fault Type Dimensions, and such nodes could, in principle have many thousands of descendants, the table SfnDimensionHierDesc is used to specify relationally which nodes to match. There are two instances of this table, one for each such Dimension.

Because only ‘leaf’ nodes are selected in the Engineer Dimension in the example selection of FIG. 1, we do not need to use the table SfnDimensionHierDesc; we can produce an enumerated check. In this case, only when non-NULL dFrom/dTo values exist is a check on the <datumSQL> included.

For some data, it is not appropriate to use the same Reducer over one of the Dimensions as it is over Time. An example of this is data representing the number of faults still ‘open’ at midnight every day. We would certainly want to add these up as we go up the Location Hierarchy, so that we can see the total number of faults in the Pipeline for a whole Region, for example. However, if we want to have one point per week, we do not want to add up all the daily values, since a fault will often be in the Pipeline for all of those days; we don't want to count this more than once. The sensible thing to do is to take the MEAN of all the daily values in this case (i.e. use MEAN to reduce over time). We then add up all the MEAN values as we go up the Fault Location Hierarchy. But what about the Fault Type Hierarchy? We must collapse all values, for a given (date, Location) pair, in this Dimension (and in general in all non-Primary Dimensions), by adding them, before taking the MEAN over time. Failure to do this will lead to incorrect results. Consider the case where, on Monday of one week, there are 10 Cabling faults and 20 Mountings faults for a particular Location, and on Tuesday there are 20 Cabling faults and 30 Mountings faults for the same Location. If we take the MEAN of all of these, we get 20, whereas if we take the MEAN of (10+20) and (20+30) we get 40.

If a different Reducer is specified for the Hierarchy, the query form is less optimised, using derived tables to effect a three-phase reduction. There is a single Dimension (the Primary Dimension) over which the Hierarchy Reducer is applied; other Dimensions get ‘collapsed’ in the inner-most Derived Table before Time Reduction occurs.

For example, in the Pipeline of outstanding Faults Measure, SUM is specified as the Hierarchy Reducer, and MEAN as the Time Reducer. The query below relates to the Dimension Hierarchy selections in FIG. 1 except that no Engineer is selected (there is no data on Engineer in the PipelineData table). The Fault Location Dimension is the Primary Dimension.

| | |
|---|---|
| SELECT nPointId_Time | AS nPointId_, |
| SUM(nRedValue_Time) | AS nRedValue_{—} |
| FROM ( | |
| SELECT <pointIdSQL(<nPointId_Dim>)> | AS nPointId_Time, |
| AVG(nRedValue_Dim) | AS nRedValue_Time, |
| id_Dim | |
| FROM ( | |
| SELECT dPipeline | AS nPointId_Dim, |
| SUM(nPipeline) | AS nRedValue_Dim, |
| H_1.cId | AS id_Dim |

```
        FROM PipelineData D_,
          SfnDimensionHierDesc H_1,
          SfnDimensionHierDesc H_2
        WHERE
          ---- Fault Location Dimension
          (H_1.cId LIKE ‘L.N.1.%’ OR H_1.cId LIKE ‘L.N.2.a.%’)
          AND H_1.cBaseId = cLocationId
          AND (H_1.dFrom IS NULL OR H_1.dFrom <= dPipeline)
          AND (H_1.dTo IS NULL OR H_1.dTo  > dPipeline)
          ---- Fault Type Dimension
          AND H_2.cId LIKE ‘T.M.%’
          AND H_2.cBaseId = cTypeId
          AND (H_2.dFrom IS NULL OR H_2.dFrom <= dPipeline)
          AND (H_2.dTo IS NULL OR H_2.dTo  > dPipeline)
          AND dPipeline IS NOT NULL
        GROUP BY dPipeline, H_1.cId
      ) DT_DIM
    GROUP BY <pointIdSQL(<nPointId_Dim>)>, id_Dim
    ) DT_TIME
  GROUP BY nPointId_Time
  ORDER BY 1
(Bold text denotes identifiers and values specific to the example Dimension Hierarchy and Pipeline Measure)
```

Here, the derived table DT_DIM contains a value (reduced over all Dimensions except the Primary Dimension) for each distinct <date, hierarchy node> pair for nodes at or below RegionN1 or Location-a whose cBaseId matches the cLocationId value in one of the rows in the Pipeline Datatable.

The derived table DT_TIME reduces these to a single value for each distinct <partition, hierarchy node> pair, by combining the values for all <date, hierarchy node> pairs where the date values fall into the same partition. This is done using the Time Reducer. Here, a partition may mean day, month, year, etc. depending on the Partitioner used.

Finally a single value for each partition is produced by the main SELECT, by combining the values for all <partition, hierarchy node> pairs with the same partition value. This is done using the Hierarchy Reducer.

Caching and Auto-Caching

In order to speed up the accessing of frequently used SPC charts the results of SPC chart queries are stored in cache memory and these results are reused whenever the same query is generated. This is a much faster computation than rerunning the query against the database.

The caching system works by associating a raw query string with the results found by that query. The cache is checked before passing the queries to the database and if a match is found the associated results are used and no database interaction occurs.

A flow diagram showing the cache query is shown in FIG. 3. In FIG. 3 the process of adding a new chart to cache is shown. In this, a determination is made as to whether or not the cache is full. If it is, the oldest entries are removed and a new entry is written.

In FIG. 3b the process of adding a computationally expensive cache is shown. A determination is made as to whether or not the query was computationally expensive. If it was, it is added to an autocache list and provided it is more expensive than other charts in the autocache list.

In FIG. 3c a chart query is shown. In this, a request for a chart generates a query. The system determines firstly whether or not a cached chart is available. If it is, then it can be used. However, if the data table for the chart has changed the chart is invalid and must be requeried and subsequently stored in the cache before it can be accessed.

Cache integrity has to be maintained. Whenever a data table in a database becomes updated, any cache results based on that data table become invalid. Therefore, with each cache entry the name of the data table from which the results were selected and the time the results were read are stored. Each data table registered for use with the system then has a row in the following database table.

SYSTEM DATATABLES

| Column name | Data Type | Notes | Null | Key |
|---|---|---|---|---|
| cDataTable | varchar(255) | The name of the Data Table. | | P |
| dUpdateStart | datetime | Time at which the last update | Y | |
| | | for this Data Table started. NULL | | |
| | | initially. | | |
| dUpdateEnd | datetime | Time at which the last update | Y | |
| | | for this Data Table ended. | | |
| | | NULL initially and when | | |
| | | update is in progress. | | |
| bEnableQueryCaching | number(1) | 1 if queries against this Data | | |
| | | Table are to be cached for | | |
| | | use with future chart requests. | | |
| bEnableAutoCaching | number(1) | 1 if ‘expensive’ queries | | |
| | | against this Data Table are | | |
| | | to be recorded in | | |
| | | SfnAutoCacheList so that | | |
| | | they will be ‘auto-cached’ on | | |
| | | Data Table update or server | | |
| | | restart. (See later section). | | |

Before a Data Table is updated, the value of dUpdateStart must be set to the current time, and dUpdateEnd must be set to NULL. This signals to the system that queries against that Data Table cannot be made at the moment, although the caching system's contents are still considered valid, and can be used. Once the update is complete, dUpdateEnd must be set to the current time, to signal that queries against this Data Table can once again be made, and the caching system's contents for queries against this Data Table are no longer valid (see Data Table Update Protocol in FIG. 3). This is checked just before looking up the generated query in the cache, and if necessary, all entries in the cache are deleted, and the current lookup will fail, leading to running the query in the database (if dUpdateEnd is not NULL) or giving an error (if it is NULL). The protocol of setting the dUpdateStart and dUpdateEnd values may be impossible to implement for some Data Tables (e.g. when data updates are carried out by an external system that cannot be changed), in which case the value of bEnableQueryCaching is set to 0, and no caching is used for this Data Table. bEnableAutoCaching is used by AutoCaching, as described in a separate section below.

There are other instances where the cache is no longer valid. These occur when changes are made to the definitions of Dimension Hierarchies. The generated query will often refer to a point in a Dimension Hierarchy that has children. If one of these children is deleted, or a new child added, the same query might produce a different result. Consequently, such operations clear the cache.

Treatment of Time-Dependent SQL

Also a query might contain a condition stating that only data relating to the last 3 hours is to be selected. This is time-dependent in the sense that the results for this query will depend on the time at which it is applied. Clearly such results cannot be cached, as they will be immediately out of date, breaking the requirement for integrity.

To overcome this problem, the SQL is examined for timedependent functions, and if any are found, the Caching system is not used.

However, this alone would be far too restrictive. Supposing the condition were that only data relating to times before the current year were to be considered. Results of such a query would in fact be valid until the end of the current year. An example of the generic SQL for such a condition is:
WHERE {dsfn DATEPART(Y, dReportDate)}<{dsfn DATEPART(Y, {dsfn NOW( )})}

In the case of Microsoft Access, this gets translated to the following raw SQL:
WHERE DATEPART(‘.y.y.y.y.’ dReportDate)<DATEPART(‘.y.y.y.y.’ NOW( ))

The system will spot the reference to current time (NOW( )), and not be able to use the Caching system. To overcome this, a generic meta-function {dsfn EVAL( . . . )} is added. The argument to this gets evaluated in the database at the time the SQL is translated from generic to raw SQL. This is used as follows:
WHERE {dsfn DATEPART{Y, dReportDate)}<{dsfn EVAL({dsfn DATEPART(Y, {dsfn NOW( )})})}

In the case of Microsoft Access, this gets translated to the following raw SQL (assuming the current year is 2004):
WHERE DATEPART(‘.y.y.y.y.’, dReportDate)<2004

There is no longer any reference to current time, and so the Caching system can be used. Should the year change to 2005 while this result is still in the cache, it will no longer be matched by the raw SQL generated for a new sChart request, which will now contain 2005, and so there is no loss of integrity.

Limiting Cache Size

The cache must not be allowed to grow indefinitely as there are limited memory resources. To overcome this, a configurable limit on the number of cache entries is provided. When this limit is reached, one or more entries must be removed before a new entry can be added (see FIG. 3a). The heuristic chosen is to remove least-recently-used entries (although this is open to configuration). Removing only a single entry would maintain the maximum number of cache entries, but would entail going through the removal process each time a new entry was added, which would be inefficient. For this reason, there is a configurable value specifying the percentage of entries to remove each time the cache fills up.

There is a configurable limit on the number of sChart points allowed in a cache entry; if this is exceeded no cache entry is made. This is because sCharts with millions of points would take an enormous amount of cache memory.

There is also an option to compress the cached results, to save on memory, but the price paid for this is the increased time required to use a cached result.

Synchronizing The Cache

If two users request the same un-cached sChart at the same time, we need to avoid querying the database twice. To do this, the code that implements cache lookup is synchronized such that only one process can populate the cache for any given query string.

The above caching system has the drawback that in certain circumstances the cached values become invalid and have to be cleared. Therefore, subsequent requests of a previously cached chart will require a query of the database which will be computationally expensive and may take some time.

To overcome this, the system embodying the invention automatically re-caches the result of sChart queries made against the database when the previously cached results become invalid as a result of data table updates, or if the server is restarted (see AutoCaching Thread in FIG. 3). This AutoCaching works as a background process which first runs at startup. After it has completed, it automatically reschedules itself to run again at a later time e.g. one minute, ten minutes, etc. Each time it runs it uses a defined set of information to check whether any autocaching is required. This information can be as follows:
A table of any sChart queries that took more than a (configurable) threshold time to run. This includes the Data Table to use. This table also contains the last request date.
A table listing the following for each <Data Table, Application Server> pair
   The time the AutoCaching last ran
   The time the Cache was last cleared
This allows the AutoCaching to function in a multiple Application Server environment
The lower threshold time: sChart queries taking longer than this to run are stored in the AutoCache list This threshold may be increased, so the AutoCaching system also filters entries against this value when it checks to see which requests to run.
The upper threshold time: The AutoCaching ignores entries in the AutoCache list whose run time was greater than this. This prevents any pathological queries from causing the AutoCaching to run for too long.

Using this information, an efficient query can be generated to see which requests from the AutoCache list need to be run. It would be possible just to run through the entire AutoCache list each time, since those requests already in the cache would return fairly quickly. However, even if 100 cached requests could be run a second, this would require 10 seconds for an AutoCache list with 1000 entries, which is a significant load on the Application Server if run every minute. By filtering out which requests need to be made, less than a second is typically required when all entries are up-to-date. This meets the business requirement of not overloading the IT infrastructure.

It may be that updates are so frequent for a particular Data Table, that AutoCaching is counter-productive, as it takes too long compared to the update period. In this case, the Data Table is flagged as not allowing AutoCaching (the column bAutoCachingEnabled in table SYSTEM DATATABLES shown in a previous section is set to 0). This prevents overloading the IT infrastructure by constant database requests.

AutoCaching can run on the basis of the most recently requested charts. Alternatively, they can be a predefined set of charts which are always autocached, or it can be a combination of these two factors, i.e. a selection of the most recently requested charts and a selection of known frequently requested charts.

1. A system for extracting user selected data from a database comprising:
means for storing configuration data defining how user selected data is to be extracted in response to a user request for data;
means for generating a database query form the user request using the configuration data;
means for extracting data in response to the query;
means for supplying the extracted data to the user;
wherein the database query comprises data defining a measure to be displayed and data defining any dimensions for that measure selected by the user, and the data defining the measure and dimensions comprise a portion of the configuration data.

2. A system according to claim 1 including means for providing a graphical display of the extracted measure data and means for enabling a user to select a dimension associated with that measure to be displayed.

3. A system according to claim 1 including means to enable a selected dimension of the data to be filtered by one or more user selected attributes within that dimension.

4. A system according to claim 1, including means to enable data filtered according to selection in one dimension to be filtered by a further selected dimension or attributes thereof.

5. A system according to claim 1 in which the means for generating a database query from the user request generates each query in the same format.

6. A method for extracting user selected data from a database comprising the steps of:
storing configuration data defining how user selected data is to be extracted in response to a user request for data;
generating a database query from a user request using the configuration data;
extracting data in response to the query;
supplying the extracted data to the user;
wherein the database query comprises data defining a measure to be displayed and data defining any dimensions for that measure selected by the user, and the data defining the measure and dimensions comprise a portion of the configuration data.

7. A method according to claim 6 including a step of providing a graphical display of the extracted measure data and a step of displaying a user selected dimension associated with that measure.

8. A method according to claim 6 including the step of filtering a selected dimension via user selected attributes within that dimension.

9. A method according to claim 7 including the step of filtering data, already filtered according selection in one dimension, by a further selected dimension or attributes thereof.

10. A method according to claim 6 in which the original step of generating a database query in response to the user request generates each query in the same format.

11. A method for supplying a set of chart data from a database to a user in response to a user input comprising the steps of:
storing a number of sets of chart data in a cache memory;
determining whether a user input corresponds to a request for a set of chart data stored in the cache memory; and
supplying a set of chart data from the cache memory in dependence on the result of the determination.

12. A method according to claim 11 in which the stored number of sets of chart data comprise recently accessed sets of chart data.

13. A method according to claim 11 in which the stored sets of chart data comprise frequently accessed chart data.

14. A method according to claim 11 in which the steps storing a number of sets of chart data stores sets of chart data up to a predetermined memory limit.

15. A method according to claim 11 including the step of regenerating one or more of the sets of chart data if the underlying data from the database has changed.

16. A method according to claim 11 including the step of removing the least recently used sets of chart data if the number of sets of chart data stored reaches a predetermined limit.

17. A method according to claim 16 in which the step of removing the least recently used sets of chart data comprises removing more than one set of chart data.

18. A method according to claim 11 in which the step of storing sets of chart data stores only sets of chart data of less than a predetermined size.

19. A method according to claim 11 in which the step of storing sets of chart data stores only sets of chart data the creation of which is considered expensive according to a configurable value.
